(19) United States
(12) Patent Application Publication
(10) Pub. No.: US 2026/0336306 A1
(43) Pub. Date: Oct. 29, 2026

(54) A Printing Method with a Liquid Droplet Generator

(71) Applicant: Agfa NV, Mortsel (BE)

(72) Inventor: Wout Verbeek, Mortsel (BE)

(73) Assignee: Agfa NV, Mortsel (BE)

(21) Appl. No.: 19/111,573

(22) PCT Filed: Jul. 4, 2023
(86) PCT No.: PCT/EP2023/068300

§ 371 Date: Mar. 13, 2025

(30) Foreign Application Priority Data
Sep. 15, 2022 (EP) 2219594.7

(51) Int. Cl. B41J 2/21; B41J 2/14; B41J 2/15

(52) U.S. Cl. CPC B41J 2/2146; B41J 2/15; B41J 2/2107; B41J 2002/14419

(57) ABSTRACT

A method of printing an halftone image by a liquid droplet generator (100), having at a first location in a manifold of the generator a liquid-sedimentation with highest density and having two inlets and; wherein the part is determined for displacing the liquid-sedimentation to a second location in the manifold by using a printmask (1000), having a width and height, which divides for a selected printing period the plurality of nozzles in minimum three sequential zones between the first inlet (516) and second inlet (517) comprising minimal for printing the determined part: a first zone (1001) at the first inlet (516) wherein the printmask (1000) determines that N1% of the part the nozzles in the first zone (1001) are used; and a second zone (1002) at the middle of the first inlet (516) and second inlet (517) wherein the printmask (1000) determines that N2% of the part the nozzles in the second zone (1002) are used; and a third zone (1003) at the second inlet (517) wherein the printmask (1000) determines that N3% of the part the nozzles in the third zone (1003) are used; whereby 100>=N1>N2>N3>=0

### TECHNICAL FIELD

The present invention relates to image formation by a liquid droplet generator wherein image quality issues due to liquid-sedimentation in the manifold of the liquid droplet generator are avoided.

### BACKGROUND ART

Image formation is a procedure whereby a digital image is printed on a medium e.g. by jetting droplets of liquid or another type of print fluid onto said medium, such as paper, plastic, a substrate for 3D printing.

Said image formation is commonly employed in apparatuses, such as printers (e.g. inkjet printer) but also facsimile machines, copying machines, plotting machines, multifunction peripherals, etc. The core of a typical jetting apparatus or image forming apparatus is one or more liquid droplet generators (also known as “printheads”) having nozzles that discharge liquid droplets, a mechanism for moving the liquid droplet generator and/or the medium in relation to one another, and a controller that controls how liquid is discharged from the individual nozzles of the liquid droplet generator onto the medium in the form of pixels.

A typical liquid droplet generator includes a plurality of nozzles aligned in one or more rows (called “nozzlerows”) along a discharge surface of the liquid droplet generator. Each nozzle is part of a “jetting channel”, which includes the nozzle, a pressure chamber, and an actuator, such as a piezoelectric actuator. A liquid droplet generator also includes a drive circuit that controls when each individual jetting channel fires based on image data. To jet from a jetting channel, the drive circuit provides a jetting pulse to the actuator, which causes the actuator to deform a wall of the pressure chamber. The deformation of the pressure chamber creates pressure waves within the pressure chamber that eject a droplet of print fluid (e.g., liquid) out of the nozzle.

Drop on Demand (DoD) printing is moving towards higher productivity and quality, which requires small droplet sizes ejected at high jetting frequencies. The print quality delivered by a liquid droplet generator depends on ejection or jetting characteristics, such as droplet velocity, droplet mass (or volume/diameter), jetting direction, etc. Unfortunately, liquid-sedimentation inside the liquid droplet generator, especially in the manifold, negatively affects the jetting characteristics and thus the image quality especially when said liquid droplet generator has a manifold with two inlets at both sides of said manifold. The liquid-sedimentation in the manifold occurs e.g. when said liquid droplet generator, filled with liquid, is not used for a long period. Such a liquid droplet generator is described in EP3536508A1 (RICOH). It is found that liquid-sedimentation issue in the manifold of such type of head results in failing nozzles and non-equal densities between the droplets of nozzles which results in annoying density profile of the liquid droplet generator.

Problems of liquid sedimentation lead to frequent maintenance of liquid droplet generators using so-called “flushing” or “washing” liquids for unclogging of nozzles and cleaning the nozzle plate of said liquid droplet generators. For example, EP 2157163 A (TOYO INK) discloses a maintenance liquid for inkjet printers comprising at least one of glycol ethers and glycol esters and 45 to 10 mg/L of dissolved oxygen. EP 1621348 A (TOSHIBA TEC) discloses a washing solution for washing a cationically UV curable inkjet ink inkjet printer head, which contains not less than 50 parts by weight of a polymerizable compound selected from the at least two kinds of polymerizable compounds included in the ink and having the lowest viscosity among the at least two kinds of polymerizable compounds, or not less than 50 parts by weight of a polymerizable compound having a viscosity of 30 mPa.s or less at ordinary temperature.

During research it is found that due the collision of the liquid from the first and second inlet at the middle of the manifold, a so-called dead zone, the liquid flow is dropped. Now, if the liquid droplet generator is not used for a certain period, liquid-sedimentation is formed at the bottom of the manifold (=which is the side closest towards the nozzles). But when the manifold is (re)filled via the first and second inlet, the liquid-sedimentation in the manifold is accumulated at said dead-zone. The liquid-sedimentation has here a higher (volumetric mass) density than the liquid on other places in the manifold. It is found that during printing, failing nozzles occur in the nozzles nearby said dead zone and/or a large print density difference occur at the nozzles nearby said dead zone. The operator has thereby to maintain the liquid droplet generator by flushing and/or cleaning or has to replace the expensive liquid droplet generator so the production time drops. Therefore, there is a need in an efficient printing method for a liquid droplet generator that has not used for a certain period and having liquid-sedimentation in the manifold without expensive time cost for maintenance procedures.

### SUMMARY OF INVENTION

It has been found that the problems described above while using a liquid droplet generator (100) having a manifold with two inlets at both side of the manifold can be overcome by a method of printing an halftone image wherein a determined part of the halftone image is printed by a plurality of nozzles, arranged in one or more rows, of the liquid droplet generator, where the liquid droplet generator has at a first location in a manifold of the liquid droplet generator a liquid-sedimentation with highest (volumetric mass) density and wherein the manifold is
having a first inlet (516) and second inlet (517) for filling the manifold with a liquid;
elongated in parallel to the plurality of nozzles between the first inlet (516) and second inlet (517); and
configured to provide a liquid path for the liquid to the plurality of nozzles; wherein the part is determined for displacing the liquid-sedimentation to a second location in the manifold by using a printmask (1000), having a width and height, which divides for a selected printing period the plurality of nozzles in minimum three sequential zones between the first inlet (516) and second inlet (517) comprising minimal for printing the determined part:
a first zone (1001) at the first inlet (516) wherein the printmask (1000) determines that that nozzles in the first zone (1001) are used for printing N1% of the part; and
a second zone (1002) at the middle of the first inlet (516) and second inlet (517) wherein the printmask (1000) determines that nozzles in the second zone (1002) are used for printing N2% of the part; and
a third zone (1003) at the second inlet (517) wherein the printmask (1000) determines that nozzles in the third zone (1003) are used for printing N3% of the part;
   whereby 100>=N1>N2>N3>=0. The manifold is preferably filled via the first and second inlet simultaneously.

By the displacement of the liquid-sedimentation nozzle failures and (print) density profiles caused by liquid-sedimentation in the manifold is solved whereby no long during maintenance (e.g. cleaning, flushing, . . . ) of the liquid droplet generator is needed and the life time of the liquid droplet generator is enlarged.

Further advantages and embodiments of the present invention will become apparent from the following description.

### DESCRIPTION OF DRAWINGS

FIG. 2 is a cross-sectional view of liquid droplet generator (100) in an illustrative embodiment as illustrated in FIG. 1. Through this cross-sectional view, the elements of (supply) manifold (314) are visible. The manifold 314 is formed by elongated body (316) of main body (302) that extends (left to right in FIG. 2) between ends (317,318). The manifold (314) is also formed by a first inlet (516) and second inlet (517) (517) that fluidly couple supply ports (330) to said opposing ends (317, 318) of elongated body (316). Thus, print fluid is supplied to the elongated body (316) at opposing ends (317, 318) in this embodiment. The elongated body (316) is a conduit for the print fluid to flow. The bottom portion of elongated body (316) and thus manifold is open to the jetting channels connected to nozzles in a nozzle row (304). Thus, elongated body (316) is the portion of (supply) manifold (314) that delivers the print fluid to the jetting channels.

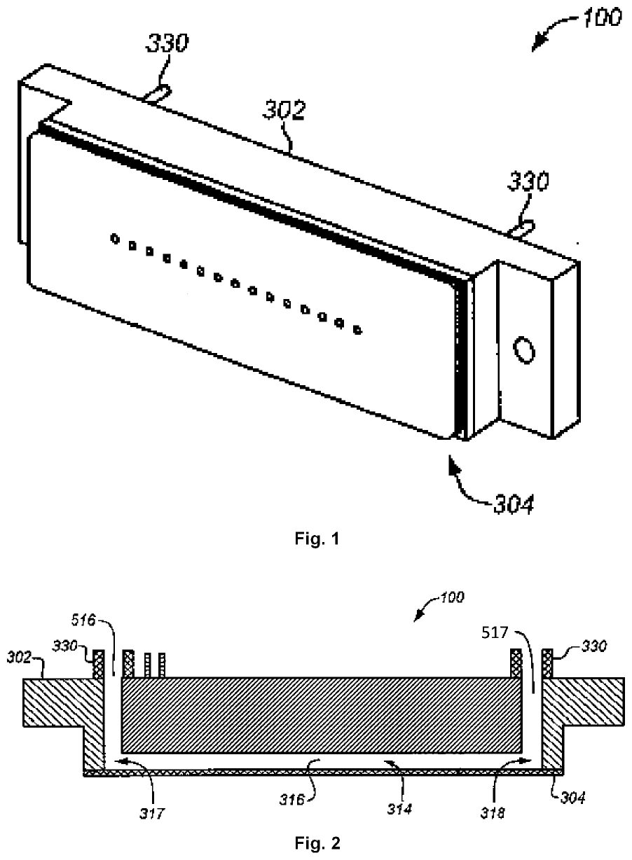

FIG. 3 illustrates as embodiment a nozzle row (304) of a liquid droplet generator (100) with 15 nozzles (illustrated as circles). The selection of nozzles for jetting are determined by a (repeatable) printmask (1000) for two-pass printing wherein said printmask (1000) has a width of 7 and height of 15 and the nozzle row is divided in three sequential zones (1001, 1002, 1003). “1” in said printmask (1000) is used for the first pass; “2” in said printmask (1000) is used for the second pass. It is clear that in the first pass nozzles in the first zone (1001) shall be used more than the nozzles in the second zone (1002) and even more than the nozzles in the third zone (1003).

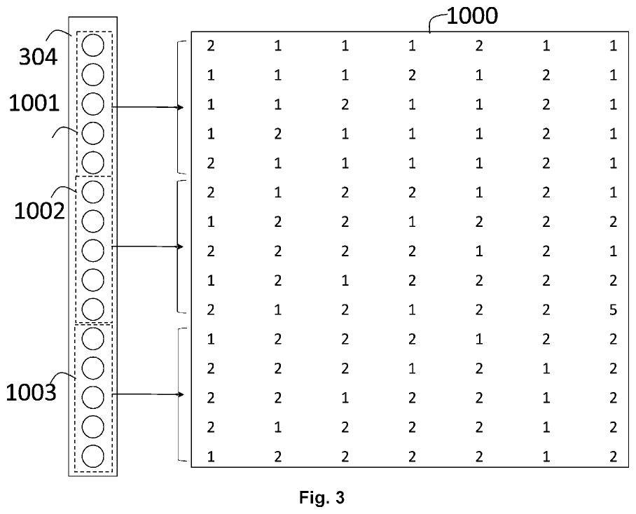

### DESCRIPTION OF EMBODIMENTS

### Liquid Droplet Generator

The liquid droplet generator (100) in the present embodiment and preferred embodiments has one or more rows of nozzles for jetting droplets of liquid, also called drop-on-demand printheads. Preferably said drop ejection is performed by using piezoelectric effects. Such printheads are nowadays dominating in home and office inkjet print systems but also in industrial applications for either printing or digital fabrication. Several actuation mechanisms are possible such as push-mode actuators or squeeze-mode actuators.

The liquid droplet generator (100) in the present embodiment has an essential manifold elongated in parallel to a nozzle row; and configured to provide a liquid path for the liquid to the plurality of nozzles. The liquid is provided by a first inlet (516) and a second inlet (517) which are connected with said manifold each at both side of said manifold. Preferably no outlet is provided as known in reflow liquid droplet generators. The speed flow of the liquid at both inlets determines the liquid flow in said manifold. Preferably the speed flow in the first inlet (516) and second inlet (517) are the same.

The liquid droplet generator (100) may have a master liquid inlet which is split in said first inlet (516) and said second inlet (517). The liquid supply is then connected to said master liquid inlet where from the liquid is further provided in said liquid droplet generator (100) via said first and second inlet (516, 517).

As already described around the middle of such manifold the liquid flow is dropped due the collision of the liquid from the first and second inlet, a so-called dead zone. Due said dead zone, liquid-sedimentation in the manifold is accumulated with a high density at said dead zone whereby during printing failing nozzles occur in the nozzles nearby said dead zone and/or a large density difference occur at the nozzles nearby said dead zone.

But by using a printmask (1000) according the present embodiment and preferred embodiments the liquid-sedimentation in the manifold can be displaced whereby the liquid droplet generator (100) can directly be used for printing without the necessary maintenance so an operator can directly start the production of printed articles.

The droplet generator is part of a multi-pass inkjet printer wherein the halftone image is printed in multiple passes and the part is jetted in a single pass. The printmask (1000) defines then the jetting of nozzles in each pass.

In a preferred embodiment, the determined part of the halftone image is additional printed by another plurality of nozzles, arranged in one or more rows, of the liquid droplet generator (100), where the liquid droplet generator (100) has at a third location in another manifold a liquid-sedimentation with highest density and wherein the other manifold is
having a third and fourth inlet for filling the other manifold with the liquid; and
elongated in parallel to the other plurality of nozzles between the third and fourth inlet; and
configured to provide an other liquid path for the liquid to the other plurality of nozzles; and wherein a complementary printmask of the printmask (1000) is additional used for determining the part for displacing the liquid-sedimentation of the liquid in the other manifold to a fourth location.

### Printing System

The liquid droplet generator (100) is preferably part of a printing system, such as an inkjet printer. The printing system is preferably for printing on flat ink receiving media but may also be a three-dimensional printing system.

In the printing system an image is formed by one or more of said liquid droplet generators which are capable of printing one ink or more inks.

The printing system is preferably configured to move the liquid droplet generator (100) for printing parts of an image, such as multi-pass inkjet printing system. A multi-pass inkjet printing method is used in the Jeti Tauro™ manufactured by AGFA NV with a maximum printable width of 254 cm and which can accommodate for example rigid media up to 400 cm in length.

The printing system may also be hybrid printing device wherein conventional printing technologies and liquid droplet technology are combined in a printing system.

The idea of displacement of the liquid-sedimentation in the manifold was tested by printing large rectangular triangles, having a base and height with a white ink after a period of non-printing. The height is oriented parallel to the nozzle row (and print direction) and the base is oriented parallel to the scan-direction of the liquid droplet generator). By adapting the base/height of the single colored triangle and/or mirroring the triangle, the displacement of the liquid-sedimentation in the manifold could be detected.

### Printmask

The use of printmasks is well known in the technical field of printing with liquid jetting technology, mainly in multi-pass inkjet printing technology.

Print masks are stored in a memory of the printing system, e.g. in a hardware or software printer driver, and control the signals applied to liquid droplet generator (100). The actual implementation of the print mask in either hardware or software formats is considered to be within the skill of those who have knowledge of the inkjet printer arts, when this skill is applied in view of the teachings herein.

The printmask (1000) in the present embodiment has a width and height, so called two-dimensional printmask (1000). The width and height are larger than 1.

The number of sequential zones may be 3, 4, 5, 6, 7, 8, 9 or 10 or equal to the width of the printmask (1000) or number of nozzles.

Preferably the printmask (1000) represents a blue noise halftoned gradient from nearest nozzle of the plurality of nozzles at the first inlet (516) to nearest nozzle of the plurality of nozzles at the second inlet (517); respectively from dark to light.

In a preferred embodiment the printmask (1000) divides for another selected printing period following the selected printing period the plurality of nozzles in other sequential zones between the first inlet (516) and second inlet (517) comprising minimal for printing the determined part:
a fourth zone at the first inlet (516) wherein the printmask (1000) determines that N4% of part is printed by the nozzles in the fourth zone are used; and
a fifth zone at the middle of the first inlet (516) and second inlet (517) wherein the printmask (1000) determines that N5% of the part is printed by the nozzles in the fifth zone are used; and
a sixth zone at the second inlet (517) wherein the printmask (1000) determines that N6% of the part is printed nozzles in the sixth zone are used;
   whereby 0>=N4>N5>N6>=100.

In a preferred embodiment the part is determined by using a printmask (1000) which divides for a determined printing period the plurality of nozzles in sequential zones between said first and second inlet (516, 517) comprising minimal
a first zone (1001) at the first inlet (516) wherein the printmask (1000) determines that 100% to 80% of the determined part is printed by the nozzles in the first zone (1001);
a second zone (1002) at the middle of the first and second inlet (516, 517) wherein the printmask (1000) determines that 70% to 30% of the determined part is printed by the nozzles in the second zone (1002) are used for printing the determined part;
a third zone (1003) at the second inlet (517) wherein the printmask (1000) determines that 20% to 0% of the determined part is printed by the nozzles in the third zone (1003) are used for printing the determined part and
   more preferably for another determined printing period following the determined printing period the plurality of nozzles in (other) sequential zones between said first and second inlet (516, 517) comprising minimal
a fourth zone at the first inlet (516) wherein the printmask (1000) determines that 20% to 0% of the determined part the nozzles in the fourth zone are used for printing the determined part;
a fifth zone at the middle of the first and second inlet (516, 517) wherein the printmask (1000) determines that 70% to 30% of the determined part the nozzles in the fifth zone are used for printing the determined part;
a sixth zone at the second inlet (517) wherein the printmask (1000) determines that 100% to 80% of the part the nozzles in the sixth zone are used for printing the determined part.

### Liquid

The liquid is preferably an ink but it may also be a varnish, primer, a coating, a cleaning liquid, a top-protection coating, pre-treatment liquid, post-treatment liquid.

Liquid sedimentation results in clogging of the liquid droplet generator (100) and poor storage stability of the liquid. They are mainly some particles of the liquid having a specific gravity between said particles and the liquid medium.

The liquid is preferably pigmented inkjet inks as the use of colour pigments provide higher light stability to the decorative laminate panels than dyes. It may be a pigmented aqueous inkjet ink or an UV curable inkjet ink. Said pigments are mainly found in said liquid sedimentation.

An aqueous inkjet ink preferably includes at least a colour pigment and water, more preferably completed with one or more organic solvents such as humectants, and a dispersant if the colour pigment is not a self-dispersible colour pigment.

An UV curable inkjet ink preferably includes at least a colour pigment, a polymeric dispersant, a photoinitiator and a polymerizable compound, such as a monomer or oligomer.

Preferably the jetting viscosity of the liquid is between 2 mPa.s and 50 mpA.s and the jetting temperature of the liquid is between 20 °C and 85 °C degrees. The jetting viscosity is measured by measuring the viscosity of the liquid at the jetting temperature. The jetting viscosity may be measured with various types of viscometers such as a Brookfield DV-II+ viscometer at jetting temperature and at 12 rotations per minute (RPM) using a CPE 40 spindle which corresponds to a shear rate of 90 s⁻¹ or with the HAAKE Rotovisco 1 Rheometer with sensor C60/1 Ti at a shear rate of 1000 s⁻¹. In a preferred embodiment the jetting viscosity is from 10 mPa·s to 200 mPa·s more preferably from 25 mPa·s to 100 mPa·s and most preferably from 30 mPa·s to 70 mPa·s. The jetting temperature may be measured with various types of thermometers. The jetting temperature of jetted liquid is measured at the exit of a nozzle in the liquid droplet generator (100) while jetting or it may be measured by measuring the temperature of the liquid in the liquid channels or nozzle while jetting through the nozzle. In a preferred embodiment the jetting temperature is from 10 °C to 100 °C more preferably from 20 °C to 60 °C and most preferably from 30 °C to 50 °C.

The liquid has preferably a pigment an average particle size larger than 100 nm more preferably 200 nm or has a pigment in an amount of more than 16 wt % based on the total weight of the liquid. Such kind of liquids are known to have issues in liquid-sedimentation in a manifold of a liquid droplet generator (100). Said pigment is preferably an inorganic pigment and most preferably a white pigment as colorant. The determination of the numeric average particle diameter is best performed by photon correlation spectroscopy at a wavelength of 633 nm with a 4 mW HeNe laser on a diluted sample of the pigmented inkjet ink. A suitable particle size analyzer used was a MalvernTM nano-S available from Goffin-Meyvis. A sample can, for example, be prepared by addition of one drop of ink to a cuvette containing 1.5 mL ethyl acetate and mixed until a homogenous sample was obtained. The measured particle size is the average value of 3 consecutive measurements consisting of 6 runs of 20 seconds.

A white pigment preferably has a numeric average pigment particle size larger than 180 nm in order to have a strong opacifying capability. Suitable white pigments are given by Table 2 in [0116] of WO 2008/074548 (AGFA GRAPHICS). The white pigment is preferably a pigment with a refractive index greater than 1.60. The white pigments may be employed singly or in combination. Preferably titanium dioxide is used as pigment with a refractive index greater than 1.60. Suitable titanium dioxide pigments are those disclosed in [0117] and in [0118] of WO 2008/074548 (AGFA GRAPHICS).

If the liquid is an UV curable based pigmented inkjet ink, the liquid has to be cured by ultraviolet radiation. An UV curing device may be arranged in combination with the liquid droplet generator (100), travelling therewith so that the UV curable inkjet ink is exposed to curing radiation very shortly after been jetted. This method of curing is called ‘UV-pinning’ and helps to provide a high image quality, such as high sharpness. UV-pinning is often followed by a final UV curing step, when the UV dose in UV-pinning is insufficient to obtain full cure. Any ultraviolet light source, as long as part of the emitted light can be absorbed by the photo-initiator or photo-initiator system, may be employed as a radiation source, such as, a high or low pressure mercury lamp, a cold cathode tube, a black light, an ultraviolet LED, an ultraviolet laser, and a flash light. Of these, the preferred source is one exhibiting a relatively long wavelength UV-contribution having a dominant wavelength of 300-400 nm. Specifically, a UV-A light source is preferred due to the reduced light scattering therewith resulting in more efficient interior curing. The UV curing and especially UV-pinning is preferably performed using UV LEDs. In a particularly preferred embodiment, the UV curing is performed using UV LEDs having an emission wavelength higher than 370 nm. UV LEDs have a long life-time and an almost constant UV dose until the end of life, contrary to e.g. mercury bulbs. For facilitating curing, the inkjet printer may include one or more oxygen depletion units. The oxygen depletion units place a blanket of nitrogen or other relatively inert gas (e.g. CO₂), with adjustable position and adjustable inert gas concentration, in order to reduce the oxygen concentration in the curing environment. Residual oxygen levels may be maintained as low as 200 ppm, but are generally in the range of 200 ppm to 1200 ppm.

1-10. (canceled)

11. A method of printing a halftone image wherein a determined part of the halftone image is printed by a plurality of nozzles, arranged in one or more rows, of a liquid droplet generator, where the liquid droplet generator has at a first location in a manifold of the liquid droplet generator a liquid-sedimentation with highest density, and wherein the manifold
(i) has a first inlet and second inlet for filling the manifold with a liquid;
(ii) is elongated in parallel to the plurality of nozzles between the first inlet and second inlet; and
(iii) is configured to provide a liquid path for the liquid to the plurality of nozzles,
wherein the part is determined for displacing the liquid-sedimentation to a second location in the manifold by using a printmask, having a width and height, which divides for a selected printing period the plurality of nozzles in minimum three sequential zones between the first inlet and second inlet comprising minimal for printing the determined part:
(a) a first zone at the first inlet wherein the printmask determines that the nozzles of the first zone are used for printing N1% of the part;
(b) a second zone at the middle of the first inlet and second inlet wherein the printmask determines that the nozzles of the second zone are used for printing N2% of the part; and
(c) a third zone at the second inlet wherein the printmask determines that the nozzles of the third zone are used for printing N3% of the part, whereby 100>=N1>N2>N3>=0.

12. The method of claim 11, wherein the printmask represents a blue noise halftoned gradient from nearest nozzle of the plurality of nozzles at the first inlet to nearest nozzle of the plurality of nozzles at the second inlet, respectively, from dark to light.

13. The method of claim 11, wherein the printmask divides for another selected printing period following the selected printing period the plurality of nozzles in sequential zones between the first inlet and second inlet comprising minimal for printing the determined part:
(d) a fourth zone at the first inlet wherein the printmask determines that N4% of the part the nozzles in the fourth zone are used for printing the part;
(e) a fifth zone at the middle of the first inlet and second inlet wherein the printmask determines that N5% of the part the nozzles in the fifth zone are used for printing the part; and
(f) a sixth zone at the second inlet wherein the printmask determines that N6% of the part the nozzles in the sixth zone are used for printing the part,
whereby 0>=N4>N5>N6>=100.

14. The method of claim 12, wherein the printmask divides for another selected printing period following the selected printing period the plurality of nozzles in sequential zones between the first inlet and second inlet comprising minimal for printing the determined part:
(d) a fourth zone at the first inlet wherein the printmask determines that N4% of the part the nozzles in the fourth zone are used for printing the part;
(e) a fifth zone at the middle of the first inlet and second inlet wherein the printmask determines that N5% of the part the nozzles in the fifth zone are used for printing the part; and
(f) a sixth zone at the second inlet wherein the printmask determines that N6% of the part the nozzles in the sixth zone are used for printing the part,
whereby 0>=N4>N5>N6>=100.

15. The method of claim 11, wherein the droplet generator is part of a multi-pass inkjet printer wherein the halftone image is printed in multiple passes and the part is jetted in a single pass.

16. The method of claim 12, wherein the droplet generator is part of a multi-pass inkjet printer wherein the halftone image is printed in multiple passes and the part is jetted in a single pass.

17. The method of claim 11, wherein the first inlet and second inlet fills the manifold with the same speed flow.

18. The method of claim 11, wherein the determined part of the halftone image is additionally printed by another plurality of nozzles, arranged in one or more rows, of the liquid droplet generator, wherein the liquid droplet generator has at a third location in another manifold a liquid-sedimentation with highest density, and wherein the other manifold
(iv) has a third and fourth inlet for filling the other manifold with the liquid;
(v) is elongated in parallel to the other plurality of nozzles between the third and fourth inlet; and
(vi) configured to provide an other liquid path for the liquid to the other plurality of nozzles; and wherein a complementary printmask of the printmask is additional used for determining the part for displacing the liquid-sedimentation of the liquid in the other manifold to a fourth location.

19. The method of claim 12, wherein the determined part of the halftone image is additionally printed by another plurality of nozzles, arranged in one or more rows, of the liquid droplet generator, wherein the liquid droplet generator has at a third location in another manifold a liquid-sedimentation with highest density, and wherein the other manifold
(iv) has a third and fourth inlet for filling the other manifold with the liquid;
(v) is elongated in parallel to the other plurality of nozzles between the third and fourth inlet; and
(vi) configured to provide an other liquid path for the liquid to the other plurality of nozzles; and wherein a complementary printmask of the printmask is additional used for determining the part for displacing the liquid-sedimentation of the liquid in the other manifold to a fourth location.

20. The method of claim 11, wherein the jetting viscosity of the liquid is between 2 mPa.s and 50 mPa.s and the jetting temperature of the liquid is between 20 C and 85 °C

21. The method of claim 12, wherein the jetting viscosity of the liquid is between 2 mPa.s and 50 mPa.s and the jetting temperature of the liquid is between 20 C and 85 °C.

22. The method of claim 20, wherein the liquid has a pigment with an average particle size larger than 150 nm and/or has a pigment in an amount of more than 16 wt % based on the total weight of the liquid.

23. The method of claim 21, wherein the liquid has a pigment with an average particle size larger than 150 nm and/or has a pigment in an amount of more than 16 wt % based on the total weight of the liquid.

24. The method of claim 22, wherein the pigment is an inorganic pigment.

25. The method of claim 23, wherein the pigment is an inorganic pigment.
